(19) United States
(12) Patent Application Publication
(10) Pub. No.: US 2019/0124881 A1
(43) Pub. Date: May 2, 2019

(54) PET BED LINER

(71) Applicant: Pettrix LLC, Miami, FL (US)

(72) Inventor: Christina Jacqueline Delgado, Miami, FL (US)

(73) Assignee: Pettrix LLC, Miami, FL (US)

(21) Appl. No.: 15/800,031

(22) Filed: Oct. 31, 2017

(51) Int. Cl. A01K 1/015

(52) U.S. Cl. CPC A01K 1/0157

(57) ABSTRACT

A pet bed liner that includes a liner body that is removably directly coupled, through adhesive disposed on the bottom surface of the liner body, to an upper surface of a deformable pet bed, and includes an upper layer of a fabric liquid-permeable material and a bottom layer of a liquid-non-permeable material, both the upper and bottom layers encapsulating an inner layup including a plurality of inner layers of a fabric material interposing a middle layer including a liquid absorption agent. The liner also includes perimeter edges forming a geometric shape contouring to a shape of the upper surface of the deformable pet bed and perforations spanning longitudinally and transversely across and substantially through the liner body, wherein said the perforations define liner segments that are operably configured to be selectively removable from the liner body along said perforations.

### FIELD OF THE INVENTION

The present invention relates generally to liners employed with pet beds, and, more particularly, relates to absorbent, adhesive, and adjustably sized pet bed liners.

### BACKGROUND OF THE INVENTION

For comfort, and in some cases medical reasons, many pet owners and/or pets desire to utilize a bed or other padding for the pet to rest or sleep. Whether a pet is untrained or suffers from a medical condition, e.g., is incontinent, many pets soil the bed, leading to the time-intensive task of cleaning the bed and pet. Additionally, many pets create saliva and shed hair, that can also lead to damaging the pet bed. In some instances, the pet bed cannot be cleaned, but rather requires complete disposal.

Some known pet beds include a deformable cushion or pillow that includes an outer layer of a liquid permeable outer layer interposing an absorbent inner layer utilized to keep an animal dry if the animal urinates. Again, to clean the cushion or pillow, it must be washed, thrown away, or the outer and inner layer must be removed, which is a time- and cost-intensive process. Moreover, pet beds with plastic liners, used to protect the bed, begin to dissolve after repeated use and get holes due to the hot water and treatment when placed in the washing machine. Additionally, handling towels and machine washable pet bed covers is unhygienic, unsanitary, and may lead to health issues. Moreover, these pet beds are sized to accommodate a particular pet size, and if the user purchases an oversized pet bed to accommodate for the pet's growth, it becomes difficult and cumbersome to store and transport.

Some other known pet beds utilize what is the equivalent to a sheet, or fitted sheet, that is designed to encapsulate or cover a typical pet bed. The cover is disposable and may include an elastic perimeter and an outer layer that superimposes an inner absorbent layer that includes an odor- and/or liquid-absorbent material. These apparatuses include many of the same disadvantages of the above pet beds, i.e., they are not able to accommodate different sized animals, they are not able to accommodate different sized pet beds, they take time to install, and the outer layer often bunches during use (causing inadvertent removal of the bed or misplacement of the absorbent layer).

Other known pet beds designed to absorb urine and other liquids, such as U.S. Pat. No. 7,559,290 (West), which is incorporated herein by reference, include an absorbent liner superimposed over a pet bed. The liner is removably coupled to the pet bed utilizing fasteners utilized on the pet and/or portions of the liner and/or utilizing “temporary adhesive.” Again, these liners are not adaptable to various sized beds, have a layup that does not sufficiently retain liquid and keep a recumbent pet dry, and/or requires specially made fasteners that not only take additional time to install and remove the liner, but are also prone to malfunction.

Therefore, a need exists to overcome the problems with the prior art as discussed above.

### SUMMARY OF THE INVENTION

The invention provides a pet bed liner that overcomes the hereinbefore-mentioned disadvantages of the heretofore-known devices and methods of this general type and that can accommodate and adapt to various sized pet beds. Also, the pet bed liner operably configured to attach to a pet bed or crate with adhesive which leaves no residue or damage to the pet bed, is comparatively inexpensive to manufacture, takes little time to install and remove, and provides sufficient liquid absorption.

With the foregoing and other objects in view, there is provided, in accordance with the invention, a pet bed liner having a liner body with a bottom surface and an upper surface opposing the bottom surface, wherein the liner body may be removably directly coupled, through adhesive disposed on the bottom surface of the liner body, to an upper surface of a deformable pet bed or other similar surface/apparatus. The liner also includes an upper layer, including the upper surface, of a fabric liquid-permeable material and a bottom layer, of a liquid-non-permeable material, wherein both the upper and bottom layers encapsulate an inner layup including a plurality of inner layers of a fabric material interposing a middle layer including a liquid absorption agent. The liner also includes perimeter edges forming a geometric shape contouring to a shape of the upper surface of the deformable pet bed and perforations spanning longitudinally and transversely across and substantially through the liner body. The perforations also define liner segments that are operably configured to be selectively removable from the liner body along the perforations.

In accordance with a further feature of the present invention, the liquid absorption agent is of a polymeric gel material.

In accordance with yet another feature of the present invention, the bottom layer may be of a liquid-non-permeable polymeric material and may be uniformly of a liquid-non-permeable polymeric material.

In accordance with an additional feature of the present invention, the liner segments are uniformly distributed across the liner body and/or are uniform in shape and size.

In accordance with a further feature of the present invention, the geometric shape is substantially the same size as the shape of the upper surface of the deformable pet bed.

In accordance with another feature, an embodiment of the present invention includes each of the liner segments having a perimeter edge formed together with only the upper and bottom layers of the liner body.

In accordance with yet another feature of the present invention, the liner segments form at least a 2×3 array of selectively removable liner segments.

In accordance with another feature, an embodiment of the present invention includes a plurality of adhesive strips coupled to the bottom surface of the liner body, wherein at least one of the plurality of adhesive strips spans across adjacently aligned liner segments spanning a liner body length defined by two opposing ends of the liner body, and wherein the plurality of adhesive strips have adhesive disposed thereon and couple the liner body to the upper surface of the deformable pet bed.

In accordance the present invention, a liner body is disclosed that also includes an upper layer, defining an upper surface, of a fabric liquid-permeable material and a bottom layer, defining a bottom surface opposing upper surface, of a liquid-non-permeable material, both the upper and bottom layers encapsulating an inner layup including a plurality of inner layers of a fabric material interposing a middle layer including a liquid absorption agent. The liner body may also include perforations spanning longitudinally and transversely across and substantially through the liner body, wherein the perforations define liner segments that are operably configured to be selectively removable along the perforations to conform to a shape of an upper surface of a deformable pet bed. The liner body may also include a plurality of adhesive strips coupled to the bottom surface of the liner body, wherein at least one of the plurality of adhesive strips spans across adjacently aligned liner segments spanning a liner body length defined by two opposing ends of the liner body, said plurality of adhesive strips having an adhesive disposed thereon that is superimposed by a paper strip liner selectively removably coupled thereto.

In accordance with yet another feature, an embodiment of the present invention also includes the paper strip liner being removed from each of the plurality of adhesive strips and the liner body removably directly coupled, to an upper surface of a deformable pet bed. In said configuration, the pet liner body has the perimeter edges forming a geometric shape conforming to a shape of the upper surface of the deformable pet bed and substantially the same size as the shape of the upper surface of the deformable pet bed.

Although the invention is illustrated and described herein as embodied in a pet bed liner, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristics for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the liner from the proximal end to the distal end.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective downward-looking view of a pet bed liner and a close-up partially cross-sectional view of said liner in accordance with one embodiment of the present invention;

FIG. 2 is a top plan view and partial close-up view of the pet bed liner of FIG. 1;

FIG. 3 is a bottom plan view of the pet bed liner of FIG. 1;

FIG. 4 is an elevational side view of the pet bed liner of FIG. 1; and

FIG. 5 is a perspective downward-looking view of an exemplary pet bed and the pet bed liner of FIG. 1.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient pet bed liner assembly that effectively and efficiently retains hair, urine, and other fluids of an animal that are released by the animal while lying thereon. Additionally, the pet bed liner can effectively adapt to pet beds of various sizes and shapes by removing sections of the pet bed liner to conform to said sizes and/or shapes. As such, whether a user wants to cover a large bed for a large pet, a small bed for a small pet, or a medium-sized upper surface of a carrying case or training crate for a medium sized pet, the user can buy a box of liners to accommodate all of the above types of pet beds.

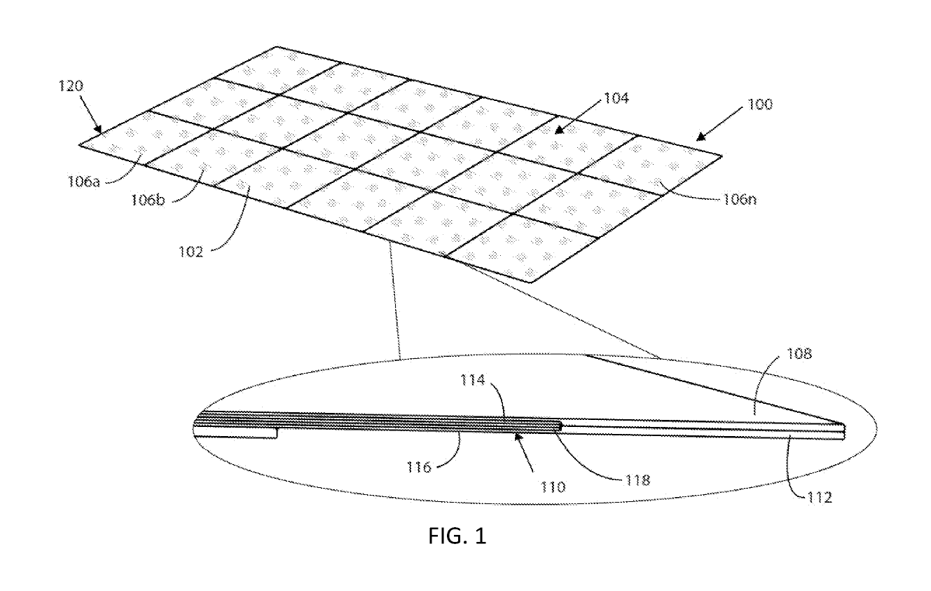

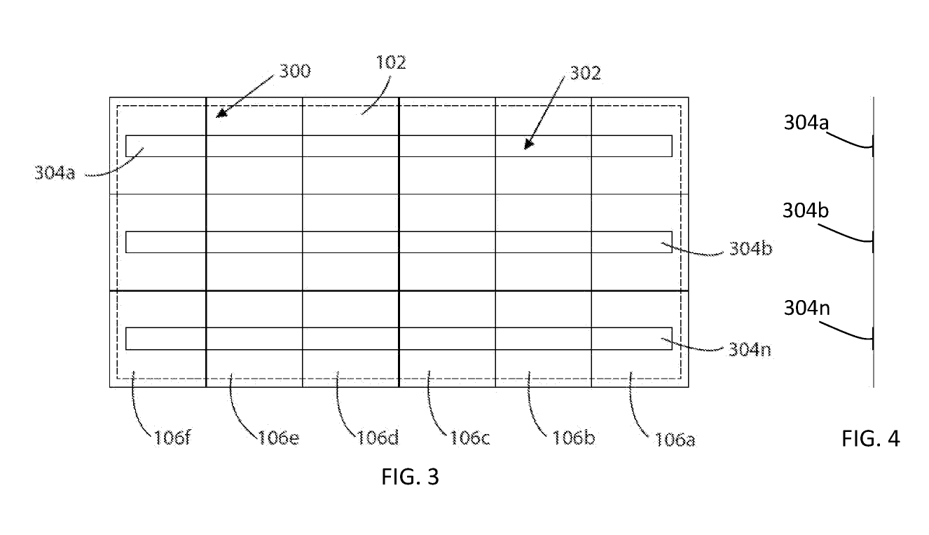

Referring now to FIG. 1, one embodiment of the present invention is shown in perspective and partially cross-sectional views. FIG. 1, along with the other figures, show several advantageous features of the present invention, but, as will be described below, the invention can be provided in several shapes, sizes, combinations of features and components, and varying numbers and functions of the components. The first example of a pet bed liner assembly 100, as shown in FIG. 1, includes a liner body 102 made up of a plurality of layers that are operably configured to absorb liquid, such as urine, within the liner body 102 that are emitted on an upper surface 104 of the liner body 102. The pet bed liner 100 also prevents said liquids from exiting the body 102 through a bottom surface 300 of the liner body 102 (shown best in FIG. 3). The bottom surface 300 opposes the upper surface 104. Beneficially, the pet bed liner assembly 100 is also adapted so that one or more sections of the liner assembly body 102 can be removed to accommodate various shapes and sizes of pet beds and other similar surfaces a pet rests.

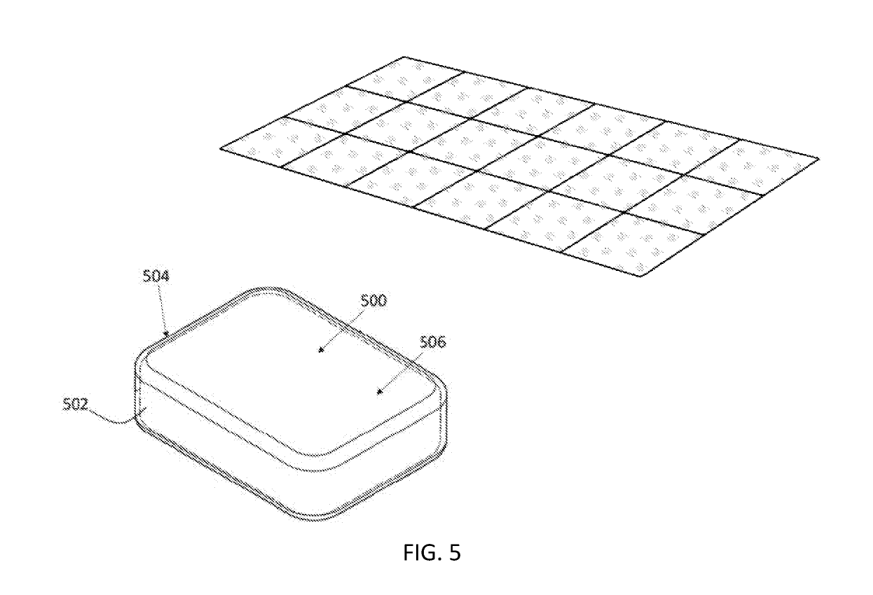

With reference specifically to FIGS. 3 and 5, in one embodiment, the liner body 102 is removably directly coupled, through adhesive 302 disposed on the bottom surface 300 of the liner body 102, to an upper surface 500 of a deformable pet bed 502. As those of skill in the art will appreciate, the term “pet bed” is any structure employed by animals to lay, rest, and/or sleep, e.g., in some embodiments, pet crates. In most embodiments, the pet bed 502 will be deformable, i.e., it can change its shape when subjected to a compression force, e.g., the weight of the animal. In one embodiment the pet bed is a cushion with walls as described in U.S. Pat. No. 5,784,995. In other embodiments, the pet bed may also be shaped and configured as described in U.S. Pat. No. 5,724,911.

Referring specifically to FIGS. 1 and 5, the pet bed generally includes an upper perimeter edge 504 generally defining the upper area 506 that includes the upper surface 500. The size and shape of the upper area 506 may deviate based on design constraints and/or the type of dog the bed is intended to accommodate. In one embodiment, the pet bed liner 100 includes a plurality of liner segments 106a-n, wherein “n” represents any number greater than 1. To fit and/or conform to a size and/or shape of the upper area 506 of the pet bed 502, the user can beneficially remove one or more liner segments 106a-n of the pet bed liner body to match said upper area 506.

In one embodiment, the upper layer 108 or sheet is of a fabric or polymeric-based liquid-permeable material, e.g., cotton, that facilitates in the transfer of liquid from the upper layer 108 to the inner liquid absorption layup 110. The upper layer 108 may also be scented. The pet bed liner body 102 includes a bottom layer 112 that may be of a liquid-non-permeable material that inhibits and/or prevents any liquid transferring through the inner liquid absorption layup 110 from exiting through the bottom surface 300 of the liner body 102. To facilitate in effectuating no liquid permeation through said layups, particularly through the sides or perimeter of said liner segments 106a-n, each of the liner segments 106a-n may form a perimeter edge, e.g., edge 120, that is formed together with only the upper and bottom layers 108, 112 of the liner body 102. The formation of said perimeter edge (or “welded edge”) may be accomplished by utilizing a heat press or heat-stamp machine or process, e.g., as described in U.S. Pat. Nos. 6,009,925, 5,545,275, or U.S. Pat. No. 5,266,150, which are incorporated herein by reference. Further, in one embodiment, the bottom layer 112 is uniformly of a liquid-non-permeable polymeric material, such as ABS plastic, while in other embodiments there are portions of the bottom layer 112 that do permit liquid to transfer therethrough.

As depicted in FIG. 1, both the upper and bottom layers 108, 112 encapsulate the inner layup 110. In one embodiment, the inner liquid absorption layup 110 includes a plurality of inner layers 114, 116 of a fabric material, e.g., cotton, interposing a middle layer 118 that includes and/or entirely consists of a liquid absorption agent. In one embodiment the inner layup 110 is disposed uniformly across the liner body 102, while in other embodiments the inner layup 110 is centrally disposed in each one of the plurality of liner segments 106a-n. The layers 114, 116 may also be of a quick-wicking tissue paper and/or a core-stabilizing tissue paper material.

In one embodiment, the liquid absorption agent (and method and/or materials for encapsulation by the middle layer 118) may consist of a polymeric gel material, such as, for example, those polymeric and other absorption agents described in U.S. Pat. Nos. 6,228,930, 5,264,495, 4,950,692; 5,478,879, 7,638,570, 9,133,342, 5,453,323, and 6,433,058, all of which are incorporated herein by reference. In one embodiment, the polymeric gel material is uniformly spread throughout the middle layer 118 to efficiently and effectively absorb liquid across at least 80-90% of the surface area of each of the liner segments 106a-n, while in other embodiments, it is intermittently spread throughout the middle layer 118.

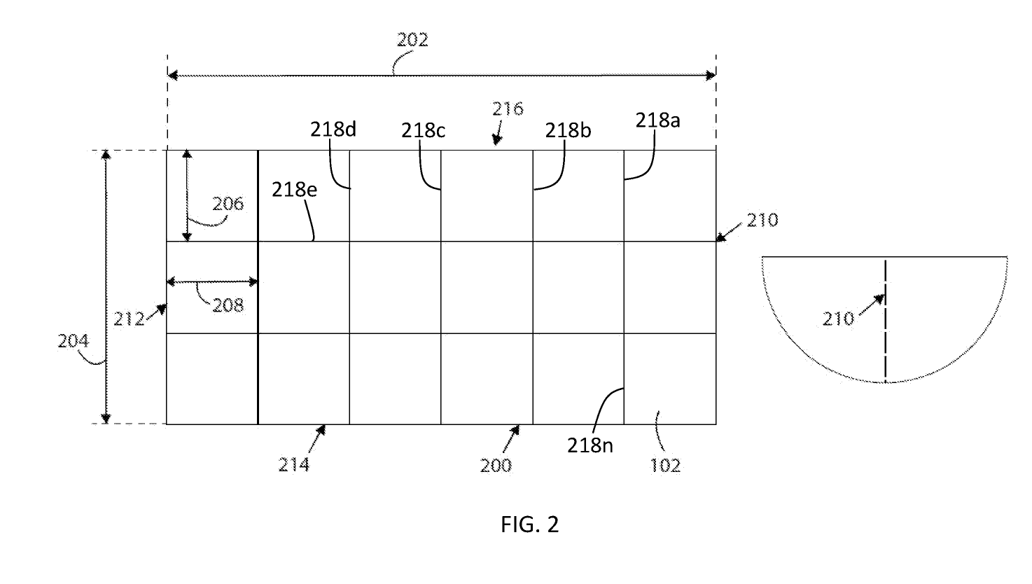

With reference now to FIGS. 2-5, perimeter edges 200 of the body 102 form a geometric shape may be operably configured to contour to a shape of the upper surface 500 of the deformable pet bed 502. Specifically, the liner body 102 may have an initial length 202 of approximately 54″, a width 204 of approximately 27″, and a thickness of approximately 40 mils (as specifically shown in FIG. 4). Each of the liner segments 106a-n may have a rectangular shape with a length 206 of approximately 9″ and a width 208 of approximately 9″. In other embodiments, other lengths, widths, and thicknesses may be employed, along with other oblong or triangular shapes and contours (for the perimeter edges 200 of the liner body 102 and each of the liner segments 106a-n).

To beneficially effectuate removal of one or more of the plurality of liner segments 106a-n, the liner body 102 may include a plurality of perforations 218a-n spanning longitudinally and transversely across and substantially through the liner body 102. Said another way, the plurality of perforations span from the proximal end 210 of the liner body 102 to the distal end 212 of the liner body 102 and from the left side 214 to the right side 216 of the body 102. The perforations 218a-n may define the plurality of liner segments 106a-n that are again operably configured to be selectively removable from the liner body 102 along said perforations 218a-n. In one embodiment, the perforations 218a-n are approximately 400 mils in length and 20 mils in width, wherein said perforations 218a-n define gaps of material of a length of approximately 80 mils. In other embodiments, said perforations 218a-n may have other dimensions and/or shapes.

The liner segments 106a-n may be uniformly distributed across the liner body 102 in equal spatial and size proportions. In other embodiments, the liner segments 106a-n may have uniform shapes or may be disposed across the liner body 102 in a non-uniform fashion. As such, when a user desires to couple or affix the liner body 102 to a pet bed 502, the user will remove an amount of liner segments 106a-n to form a shape and/or size that corresponds to the upper area 506 and/or surface 500 of the pet bed 502, i.e., to cover sufficient area of the upper surface 500 of the pet bed 502 to reduce the likelihood that an animal's urine will penetrate or reach the pet bed 502. Said another way, a geometric shape formed by the removal of the one or more liner segments 106a-n may be substantially the same size (i.e., +/−approximately 10%) as the shape of the upper surface 500 of the pet bed 502. To ensure the liner body 102 has sufficient versatility to cover various-sized surfaces 500 or area 506 of a pet bed 502, the liner segments 106a-n may form at least a 2×3 array of selectively removable liner segments 106a-n.

With reference specifically to FIGS. 3 and 5, the liner body 102 may be affixed to the upper surface 500 of the pet bed 502 with a plurality of adhesive strips 304a-n coupled to the bottom surface 300 of the liner body 102. In one embodiment, at least one of the plurality of adhesive strips 304a-n span across adjacently aligned liner segments 106a-n, e.g., segments 106a-f, spanning a liner body length (e.g., length 202 depicted in FIG. 2) defined by two opposing ends 210, 212 of the liner body 102. The plurality of adhesive strips 304a-n have an adhesive disposed thereon, effectuating direct coupling of the liner body 102 to the upper surface 500 of the deformable pet bed 502. As the liner assembly 100 is designed to be disposable, the adhesive should provide a chemical bonding sufficient to resist approximately 1-2 lbf in tension, should be non-toxic, and low odor. For example, in one embodiment, the adhesive may be a pressure sensitive adhesive (PSA) that is acrylate-based. In other embodiments, the adhesive may be hydrocolloid-based, an epoxy, or another adhesive that adequately prevents the liner body 102 to adhere to the pet bed without bunching and with a low probability of inadvertent removal.

In preferred embodiments, the bottom surface 300 of the liner body 102 has an adhesive strip coupled thereto and spanning longitudinally or transversely across each adjacently liner segment. Said adhesive strips 304a-n may be approximately 2″ in width, span approximately 80% of the liner body length in which they are disposed, and may be centrally located (and equally spaced apart) on each one of the respective liner segments 106a-n. Moreover, the plurality of adhesive strips 304a-n may have an adhesive disposed thereon that is superimposed by a paper strip liner that may be selectively removably coupled thereto (when desired for coupling with the pet bed). In one embodiment, each adhesive strip 304a-n has its own paper strip liner, while in other embodiments, the entire bottom surface has one continuous paper strip liner. Additionally, to effectuate efficient removal of one or more liner segments 106a-n initially forming a size and shape of the liner body 102, and attachment of the liner body 102/segments 106a-n forming a size and shape of the liner body 102 after segment removal (or “desired liner configuration”), the perforations 218a-n also span through the liner strips 304a-n and paper disposed on the back thereon.

While a specific order of executing the process steps for installation, removal, and/or production of said pet bed liners has been disclosed, said order of executing the steps may be changed in certain embodiments and for certain design applications. Also, some of the above-described steps may be carried out concurrently or with partial concurrence in some embodiments. Certain steps may also have been omitted for the sake of brevity.

Therefore, a pet bed liner has been disclosed that beneficially resists complete liquid transmission and accommodates pet beds and other surfaces having various sizes and shapes. To accommodate the sizes and shapes of different pet beds, the pet bed liner provides selectively removable liner segments, thereby providing a versatile, effective, and relatively inexpensive solution to animals having urination and incontinence issues while resting or lying on a pet bed.

1. A pet bed liner comprising:
a liner body with a bottom surface and an upper surface opposing the bottom surface, the liner body removably directly coupled, through adhesive disposed on the bottom surface of the liner body, to an upper surface of a deformable pet bed, and having:
an upper layer, including the upper surface, of a fabric liquid-permeable material and a bottom layer, of a liquid-non-permeable material, both the upper and bottom layers:
encapsulating an inner layup including a plurality of inner layers of a fabric material interposing a middle layer including a liquid absorption agent;
heat welded together to define a plurality liner segments and welded edges completely surrounding the liner segments; and
having aligned perforations spanning longitudinally and transversely across and substantially therethrough, the perforations disposed on the welded edges that are operably configured to enable the plurality of liner segments to be independently and selectively removable from the liner body along the perforations; and
perimeter edges forming a geometric shape contouring to a shape of the upper surface of the deformable pet bed.

2. The pet bed liner according to claim 1, wherein:
the liquid absorption agent is of a polymeric gel material.

3. The pet bed liner according to claim 2, wherein:
the bottom layer is of a liquid-non-permeable polymeric material.

4. The pet bed liner according to claim 2, wherein:
the bottom layer is uniformly of a liquid-non-permeable polymeric material.

5. The pet bed liner according to claim 1, wherein:
the plurality of liner segments are uniformly distributed across the liner body.

6. The pet bed liner according to claim 5, wherein:
the plurality of liner segments are uniform in shape and size.

7. The pet bed liner according to claim 6, wherein:
the geometric shape is substantially the same size as the shape of the upper surface of the deformable pet bed.

8. (canceled)

9. The pet bed liner according to claim 1, wherein:
the plurality of liner segments form at least a 2×3 array of selectively removable liner segments.

10. The pet bed liner according to claim 1, further comprising:
a plurality of adhesive strips coupled to the bottom surface of the liner body, wherein at least one of the plurality of adhesive strips spans across adjacently aligned liner segments spanning a liner body length defined by two opposing ends of the liner body, the plurality of adhesive strips having the adhesive disposed thereon, having the aligned perforations of the upper and bottom layers therethrough, and coupling the liner body to the upper surface of the deformable pet bed.

11. A pet bed liner comprising:
a liner body with:
an upper layer, defining an upper surface, of a fabric liquid-permeable material and a bottom layer, defining a bottom surface opposing the upper surface of the liner body, of a liquid-non-permeable material, both the upper and bottom layers:
encapsulating an inner layup including a plurality of inner layers of a fabric material interposing a middle layer including a liquid absorption agent;
heat welded together to define a plurality of liner segments and welded edges completely surrounding the liner segments; and
having aligned perforations spanning longitudinally and transversely across and substantially therethrough, the perforations disposed on the welded edges that are operably configured to enable the plurality of liner segments to be independently and selectively removable from the liner body along the perforations; and
a plurality of adhesive strips coupled to the bottom surface of the liner body and having the aligned perforations of the upper and bottom layers therethrough, wherein at least one of the plurality of adhesive strips spans across adjacently aligned liner segments spanning a liner body length defined by two opposing ends of the liner body, the plurality of adhesive strips having an adhesive disposed thereon that is superimposed by a paper strip liner selectively removably coupled thereto.

12. The pet bed liner according to claim 11, wherein:
the bottom layer is of a liquid-non-permeable polymeric material.

13. The pet bed liner according to claim 12, wherein:
the bottom layer is uniformly of a liquid-non-permeable polymeric material.

14. The pet bed liner according to claim 11, wherein:
the plurality of liner segments are uniformly distributed across the liner body.

15. The pet bed liner according to claim 11, wherein:
the plurality of liner segments are uniform in shape and size.

16. The pet bed liner according to claim 11, wherein the paper strip liner is removed from each of the plurality of adhesive strips and the liner body is removably directly coupled, to an upper surface of a deformable pet bed, the pet liner body further comprising:
perimeter edges forming a geometric shape conforming to a shape of the upper surface of the deformable pet bed and substantially the same size as the shape of the upper surface of the deformable pet bed.

17. (canceled)

18. The pet bed liner according to claim 11, wherein:
the plurality of liner segments form at least a 2×3 array of selectively removable liner segments.
